(19) United States
(12) Patent Application Publication
(10) Pub. No.: US 2002/0111862 A1
(43) Pub. Date: Aug. 15, 2002

(54) Personal account collecting system capable of readily collecting informations of accounts of persons

(76) Inventor: Hidehiro Matsumoto, Tokyo (JP)

Correspondence Address: DICKSTEIN SHAPIRO MORIN & OSHINSKY LLP, 1177 Avenue of the Americas, 41st Floor, New York, NY, 10036-2714, US

(21) Appl. No.: 10/071,200

(22) Filed: Feb. 11, 2002

(30) Foreign Application Priority Data
Feb. 9, 2001 (JP) 2001-034167

(51) Int. Cl. G06F 17/60

(52) U.S. Cl. 705/14

(57) ABSTRACT

In a personal account collecting system, when an user A utilizes a service for providing information managed by an information provider on an Internet 1 by getting access to the service through a mobile site 6 on the Internet 1, the user A introduces an another user B as a pair person for utilizing the service through a human network. Information of an account of another user is thereby collected on a database of the service site for providing information.

### Background of the Invention

The present invention relates to a personal account collecting system for use in collecting information of personal accounts by the use of human networks and a method of collecting the same.

Conventionally, advertisements have been carried out generally with a target of unidentified many people. Conventional advertising medium has therefore a purpose of distributing advertising information to such unidentified people. However, advertisements should be originally for the purpose of providing necessary information to persons who require such information. In the conventional advertising medium, as mentioned above, it is difficult to provide necessary information only to the persons who require such information.

On the other hand, with the spread of a personal telephone having a function to get access to an Internet (hereunder called “Internet personal telephone”), we have been able to easily send electronic mails (E-mails) to our mates or to obtain necessary information from WWW (World Wide Web) site. Thus, since the Internet including radio networks has come into wide use as a kind of public property, applications or services have been conducted over the wide fields, such as a social life, business, a hobby of a person, and the like. Further, services for distributing information of advertisement, and so on by the use of the Internet have been increased. In such services, the Internet is regarded as a part of life space, like a broadcasting network.

The Internet personal telephone is used with belonging to a person. Telephone call per each person is presumed in the Internet personal telephone. The Internet personal telephone is usually used with the power supply thereof being put on every time. It becomes possible to carry out adequate advertisements with a target of a person by transmitting advertising information through the Internet personal telephone.

Thus, advertisements can be carried out with selectively targeting identified persons by using the Internet personal telephone. It is therefore assumed that the advertisements can be carried out effectively. However, when any advertiser wishes to conduct the advertisements by using the Internet personal telephone, it is necessary for the advertiser to know an account of each person. Herein, the account is defined as “identifying information determined for a person who gets access to the Internet”. A conclusive factor is numbers of collected accounts of persons in order to enable such advertisements using the Internet personal telephone to be carried out so effectively.

However, major part of Internet users generally intend to keep their accounts secret as one of personal information to protect their privacies. Accordingly, it is usually difficult to collect information of the accounts of persons.

Thus, it is necessary to know the information of the accounts of persons in order to conduct advertisement for persons or introduce users' intention for purchase to related traders through the Internet. The information of the accounts of persons is not disclosed easily, because the persons wish to protect their privacies.

### SUMMARY OF THE INVENTION

It is therefore an object of the present invention to provide a personal account collecting system which is capable of easily collecting information of the accounts of persons by releasing the bar of privacy protection.

Other objects of the present invention will become clear as the description proceeds.

According to an aspect of the present invention, there is provided a personal account collecting system for use in collecting information of accounts of persons on Internet, comprising: managing means of an information provider for managing a service site for providing information on the Internet; means of a first user for getting access to the service site for providing information through a mobile site on the Internet in order to utilize the service site for providing information; introducing means of the first user for introducing a second user, as a target utilizing the service site for providing information, who is connected with the first user by human networks; and collecting means of the information provider for collecting information of an account of the second user in a data base of the service site for providing information.

The first user, by the use of a mobile personal telephone, may get access to the service site for providing information through a mobile site established on the Internet by a communication service provider.

The information provider may be an advertising agent.

Not only the information of an account of the second user but also information of a favor of the second user may be registered in the data base of the service site for providing information, the advertising agent transferring an advertisement to the second user in response to the information of a favor of the second user.

The communication service provider may provide circumstances for establishing the service site for providing information managed by the information provider on the Internet, the communication service provider, in reward for the provision of the circumstances, obtaining advertisement charges from the advertising agent, responsive to an advertisement provided by the advertising agent.

The communication service provider may further provide the advertising agent with information of numbers of accesses to the mobile site by the first and second users responsive to an advertisement provided by the advertising agent.

The communication service provider may further provide the advertising agent with information of numbers of accounts collected by the collecting means of the information provider responsive to an advertisement provided by the advertising agent.

The information of an account of the second user may be an electronic mail address of the second user.

The human networks may be based on reliable human relations so that the second user is a family, a relative, a friend, or the like of the first user.

According to another aspect of the present invention, there is also provided a method of collecting a personal account for use in collecting information of accounts of persons on Internet, the method comprising the steps of: an information provider's managing a service site for providing information on the Internet; a first user's getting access to the service site for providing information through a mobile site on the Internet in order to utilize the service site for providing information; the first user's introducing a second user, as a target utilizing the service site for providing information, who is connected with the first user by human networks; and the information provider's collecting information of an account of the second user in a data base of the service site for providing information.

### BRIEF DESCRIPTION OF THE DRAWINGS

FIG. 1 is a block diagram for schematically showing the personal account collecting system according to a preferred embodiment of the present invention;

FIG. 2 is a block diagram for schematically showing an example of contents of information services managed by an advertising agent;

FIG. 3 is a sequence chart for schematically showing proceedings of collecting information of accounts of users by the advertising agent;

FIG. 4 is a sequence chart for schematically showing proceedings of transferring advertising information to users using the collected information of accounts of the users by the advertising agent; and

FIG. 5 is a block diagram for schematically showing examples of application of the personal account collecting system according to the preferred embodiments of the present invention.

### DETAILED DESCRIPTION OF THE PREFERRED EMBODIMENTS

In the composition of the present invention, when an user utilizes a service site for providing information managed by an information provider on the Internet, the user introduces an another user as a pair person for utilizing the service site through a human network based on a reliable human relation, such as a family, a relative, a friend of the user, and the like. Information of an account of another user is thereby collected on a database of the service site for providing information. As a result, account information of another user having a human network with the user as well as account information of the user can be disclosed in deference to the wishes of the user and another user. Thereby, information of the accounts of persons can be collected by releasing the bar of privacy protection.

Further, the information provider can send the another user introduced by the user not only an advertisement but also such information as a trigger of the another user's action for purchasing goods by collecting account information and simultaneously collecting information of a favor of the user or information related to purchasing action thereof from the user.

Moreover, in a case that another user introduced by the original user again utilizes the service site for providing information to transfer necessary information to the original user, information of a favor of another user or account information thereof can further be collected.

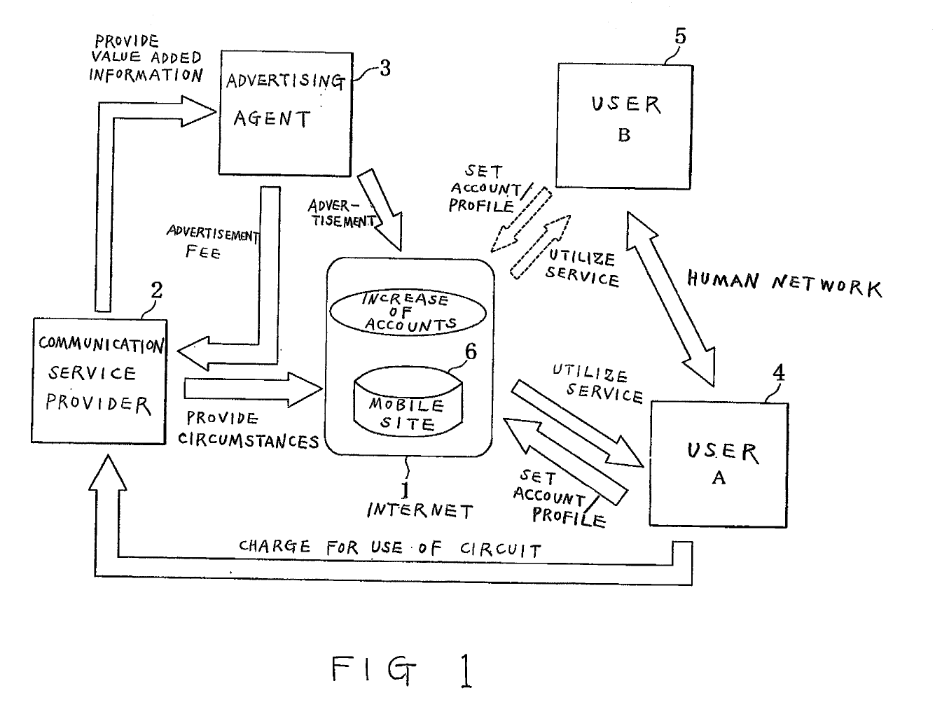

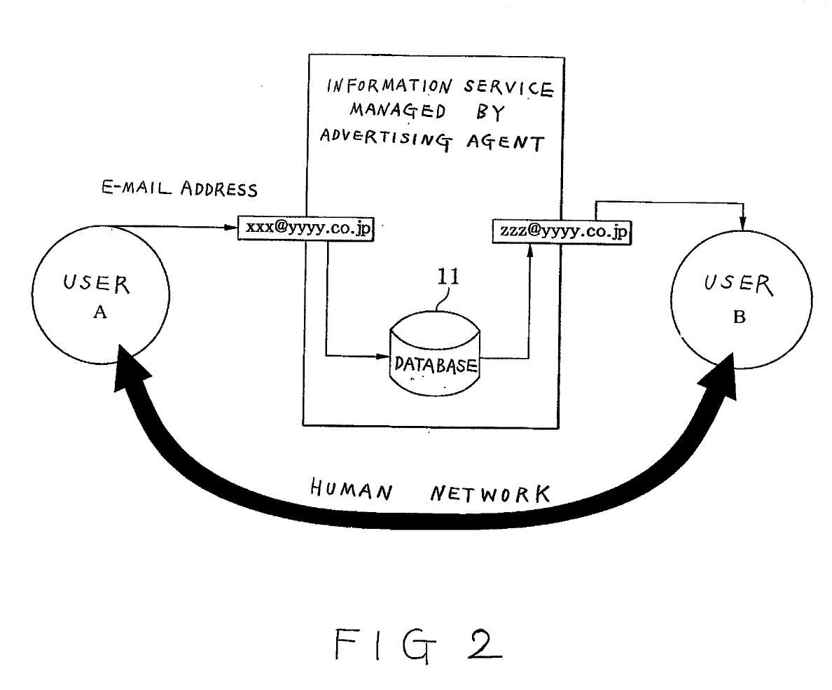

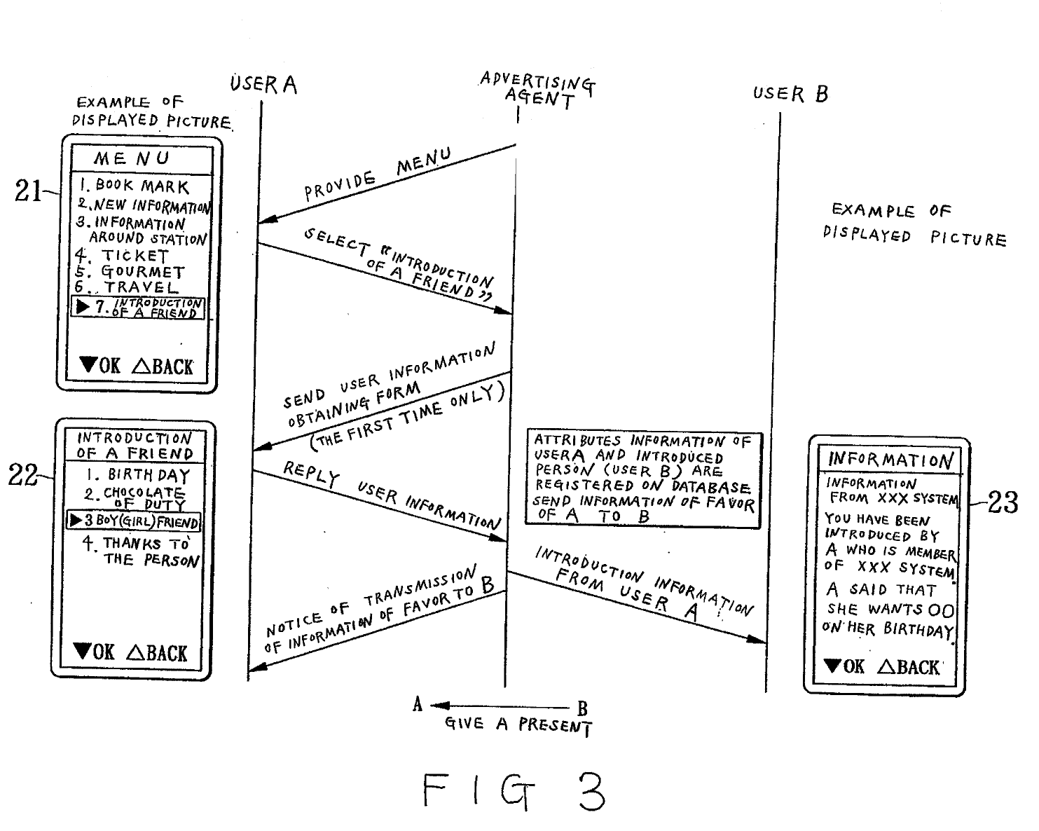

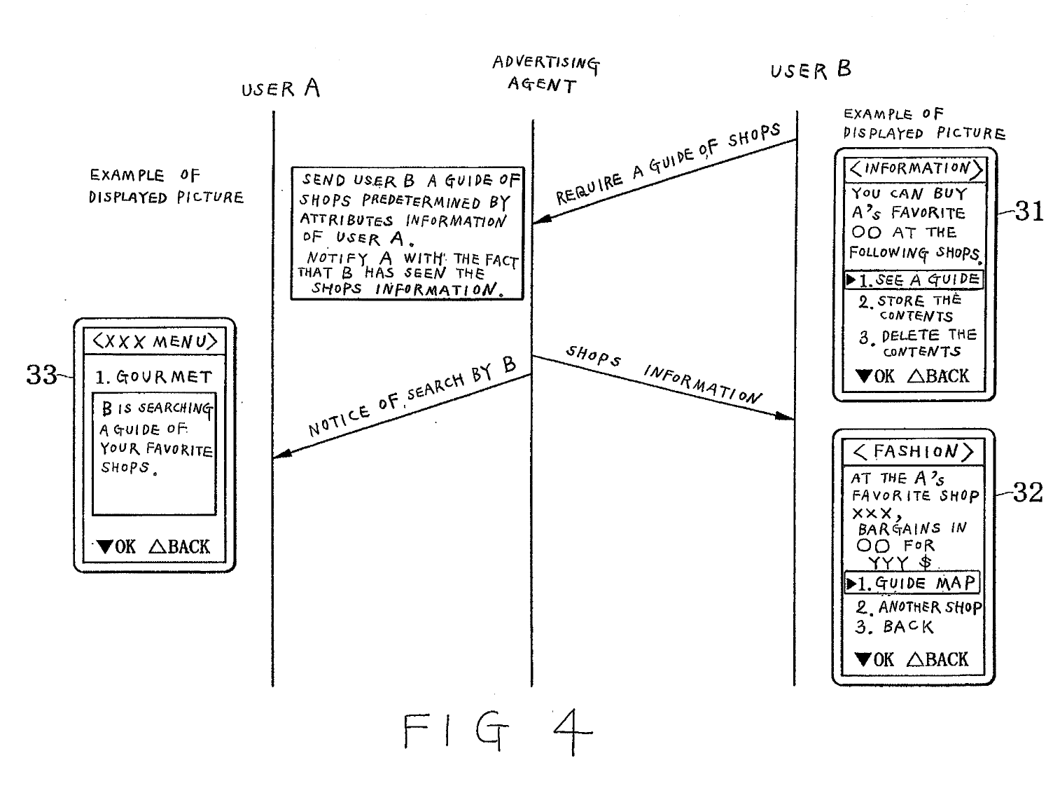

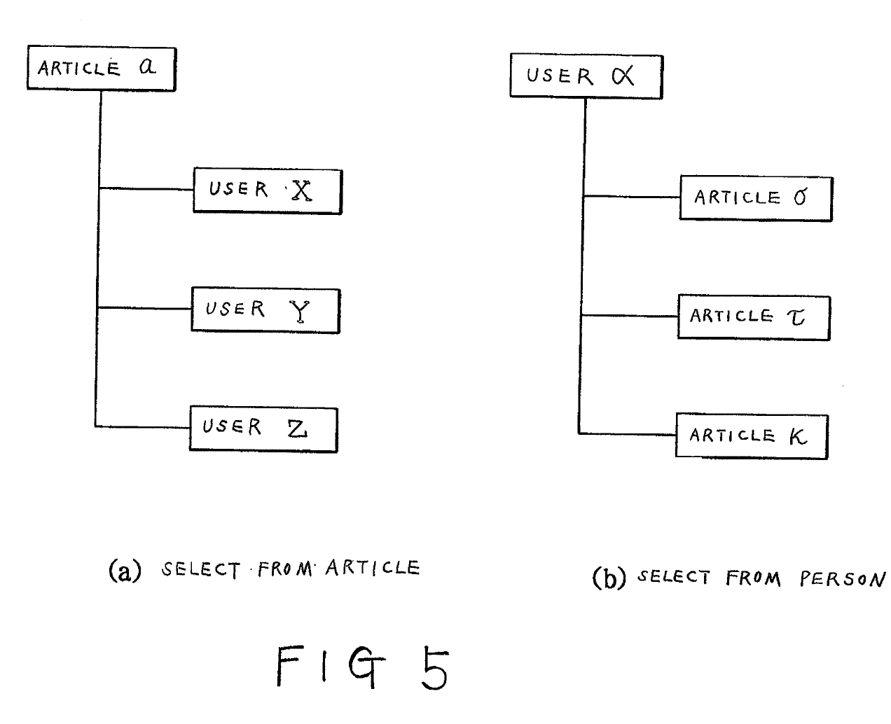

Now, referring to FIGS. 1 through 5, description will proceed to a personal account collecting system according to preferred embodiments of the present invention. FIG. 1 is a block diagram for schematically showing the personal account collecting system according to a preferred embodiment of the present invention. FIG. 2 is a block diagram for schematically showing an example of contents of information services managed by an advertising agent. FIG. 3 is a sequence chart for schematically showing proceedings of collecting information of accounts of users by the advertising agent. FIG. 4 is a sequence chart for schematically showing proceedings of transferring advertising information to users using the collected information of accounts of the users by the advertising agent. FIG. 5 is a block diagram for schematically showing examples of application of the personal account collecting system according to the preferred embodiments of the present invention.

As illustrated in FIG. 1, the personal account collecting system includes the Internet 1, a communication service provider 2, an advertising agent 3, a user A 4, and a user B 5.

The Internet 1 connects the communication service provider 2, the advertising agent 3, the user A 4, and the user B 5 with each other. The communication service provider 2 establishes a Mobile Site 6 and then manages the Mobile Site 6 on the Internet 1. Further, the communication service provider 2 arranges and maintains circumstances in which contents of advertisement or information can be provided to the users A and B. Moreover, the communication service provider 2 charges the users A or B for the use of the circuit, and the like, when the users A or B utilize information of the Mobile Site 6.

The advertising agent 3 pays an advertisement fee to the communication service provider 2. The communication service provider 2 thereby inserts an advertisement proposed by the advertising agent 3 as contents into the Mobile Site 6. Frequency of reading the advertisement can be identified by numbers of the users A and B having got access to the Mobile Site 6 or numbers of the information of the accounts. Advertising effects of the advertisement can be analyzed by such data. The communication service provider 2 transfers the data to the advertising agent 3 as value added information responsive to the above-mentioned advertisement fee.

The user A 4 and the user B 5 utilize information existed in the Mobile Site 6 on the Internet 1 by the use of an Internet personal telephone having a function to get access to the Internet 1. At that time, the user A 4 and the user B 5 pay for the use of the circuit, and the like to the communication service provider 2.

In FIG. 2, illustrated are contents of information service managed by the advertising agent 3. The information service is such a service that is established in a site of the Internet by a computer, such as a personal computer, a work station, and the like, provided by the advertising agent 3. The advertising agent 3 has a database 11 in which necessary data are stored for the information service.

Next, description is made about a function of the personal account collecting system according to this embodiment of the present invention. Hereunder, description will be made, assumed that the user A and the user B are connected with each other by a human network, that the user A already has account information to the Mobile Site 6, but that the user B does not have such an account to the Mobile Site 6. Besides, the human network is a reliable human relation, such as a family, a relative, a friend, or the like of the user.

The user A has acquired an electronic mail (E-mail) address (xxx@yyyy.co.jp) as account information. When the user A has utilized the information service managed by the advertising agent 3 through the Mobile Site 6, the account information of the user A is stored in the data base 11 accompanied with the information service. When the user A 4 willingly introduces the user B, intention for purchase, and the like of the user A is stored in the data base 11. Proceedings of introducing the user B in this case is to store an electronic mail (E-mail) address (zzz@yyyy.co.jp) of the user B in the data base 11.

The information related to purchasing actions of the user A (information of, for example, a hobby, a shop that the user A frequently uses, favor for clothes, and the like, etc..) are rendered to be related to information of shops, goods, and the like in the data base 11 within the information service. The information related to purchasing actions of the user A are then sent to the user B as an information of a present from the user A by using the account information (zzz@yyyy.co.jp) of the user B. The user B can thereby recognize that the source of the information is the user A and the information is sent from the information service managed by the advertising agent 3.

Next, description proceeds to the proceedings of collecting the information of the accounts of the users by the advertising agent 3. FIG. 3 shows the proceedings of collecting the information of the account of the user B by the advertising agent 3, when the user A introduces the user B.

Besides, the following example is such a case that the user A gets a present from the user B, “a boyfriend” of the user A by using the information service of the advertising agent 3. In this case, the advertising agent 3 gives a notice to the user B from the information service site with an advertisement for the goods being added to the notice. During the process, the advertising agent 3 obtains the information of the account of the user B introduced by the user A.

At first, the user A gets access to the information service site managed by the advertising agent 3. The user A then selects “introduction of a friend” from a menu of an example of a displayed picture 21 sent from the information service site. In response thereto, only for the first time, “introduction of a friend” illustrated in an example of a displayed picture 22 is sent to the Internet personal telephone of the user A from the information service site as a displayed picture for obtaining the information related to purchasing actions of the user A (user information obtaining form).

The user A gives a reply to the information service site for the user information, that is, the information related to purchasing actions of the user A, in accordance with the user information obtaining form. The user A thereby not only notifies the information service site of the advertising agent 3 with information of attributes of the user A (a boyfriend) and the information related to purchasing actions of the user A but also discloses the information of the account of a person to be introduced (the user B). In the information service site, the information replied from the user A is registered on the database 11. In the example illustrated in FIG. 3, it is assumed that the user A has notified, as the information related to purchasing actions of the user A, the information service site with goods that she would like the user B to present her, so that the goods have been registered on the data base 11.

The information service site then transmits such an information electronic mail (E-mail) as illustrated in an example of a displayed picture 23 to the user B. In this information electronic mail (E-mail), it is shown that the information electronic mail (E-mail) has been transmitted to the user B based on the information introduced by the user A. Further, the information electronic mail (E-mail) has been transmitted to the user B in order to advise the user B with the goods that the user A hopes. In addition, the information service site notifies the user A that the information of a favor of the user A has been transmitted to the user B.

Next, description will proceed to the proceedings of transmitting advertising information by the advertising agent 3 using the collected account information. In FIG. 4, illustrated are proceedings of transmitting information for shops as the advertising information to the user B introduced by the user A.

Following to the information electronic mail (E-mail) transmitted by the proceedings of FIG. 3, the information service site then transmits such another information electronic mail (E-mail) as illustrated in an example of a displayed picture 31 to the user B. The user B deletes another information electronic mail (E-mail), if he is not interested in the contents of another information electronic mail (E-mail). On the contrary, if the user B is interested in the contents thereof, the user B selects the information related to the corresponding goods and notifies the information service site with the corresponding goods. In this case, the user B requires a guide of the shops from the information service site by selecting “see a guide”.

From the information service site, the guide of the shops predetermined responsive to the information of attributes of the user A is transmitted to the user B. As information of the shops in this case, such information illustrated in an example of a displayed picture 32, which is predetermined based on the information of attributes of the user A and includes a guide of the shops related to the above-mentioned goods as well as the advertisements thereof, is transmitted to the user B. In the example of the displayed picture 32, illustrated is such a shop related to, for example, fashion. The user B can let the information service site transmit a guide map of the shop to the user B, if necessary, by selecting “guide map”.

At the same time, by the xxx menu illustrated in an example of a displayed picture 33, the information service site notifies the user A with the fact that the user B has been advised with the goods she hopes and is thereby searching the corresponding shop xxx.

Thus, in the personal account collecting system according to this embodiment of the present invention, a user introduces another user by way of a human network. Thereby, the information of the accounts of persons can be collected, although they are not disclosed easily. Accordingly, the advertisement, and the like can be effectively carried out by using the information of the accounts.

As described above, although the present invention has thus far been described for only a preferred embodiment thereof with reference to FIGS. 1 through 4, it will now be readily possible for those skilled in the art to put the present invention into various other manners. For example, in the above preferred embodiment, another user that the user □ intends to introduce is identified by selecting from a person, as illustrated in FIG. 5B. Then, articles (σ, τ, κ) are proposed. However, the pair user (X, Y, Z) can be designated by selecting from an article a, as illustrated in FIG. 5A. An example of the case is that a user identifies an adequate article a, for example, like a gift, a midyear gift, and the like, so that the user designates the pair user.

Further, in the above-preferred embodiment, description was made about the case that personal accounts were collected in the information service managed by an advertising agent. However, it is not restricted to such an advertising agent. In other words, a general information provider can collect the personal accounts by a similar management. Moreover, the information of the account of a person is not restricted to such an address of the electronic mail (E-mail). Another information can be the information of the account of a person, if it is identifying information for getting access to an information service on the Internet.

Furthermore, in the above-preferred embodiment, description was made as regards the case that the user A introduced the user B. However, after the user B has once been introduced, information of a favor, information related to purchasing action, an account information of the user B can further be collected, by the user B using the information service of this embodiment again to transfer necessary information to the user A.

As described above, in a personal account collecting system according to the preferred embodiments of the present invention, the personal account information, which are not easily disclosed conventionally for an aspect of privacy protection, can be collected by the user introducing another user through a human network. Therefore, the advertising agent and any other information providers can effectively conduct an advertisement to the users or cause an action of the users for purchasing goods by the use of such personal account information.

Further, the personal account information having thus been stored can be secondarily used as data for market analysis. On the other hand, when the user has a message that the user cannot readily send directly to the another user, the user can expect usefulness that the message is sent indirectly to the another user by way of the information service site of the advertising agent, and the like.

What is claimed is:

1. A personal account collecting system for use in collecting information of accounts of persons on Internet, comprising:
managing means of an information provider for managing a service site for providing information on the Internet;
means of a first user for getting access to said service site for providing information through a mobile site on the Internet in order to utilize said service site for providing information;
introducing means of said first user for introducing a second user, as a target utilizing said service site for providing information, who is connected with said first user by human networks; and
collecting means of said information provider for collecting information of an account of said second user in a database of said service site for providing information.

2. A personal account collecting system as claimed in claim 1, wherein said first user, by the use of a mobile personal telephone, gets access to said service site for providing information through a mobile site established on the Internet by a communication service provider.

3. A personal account collecting system as claimed in claim 1, wherein said information provider is an advertising agent.

4. A personal account collecting system as claimed in claim 3, wherein not only said information of an account of said second user but also information of a favor of said second user are registered in said data base of said service site for providing information, said advertising agent transferring an advertisement to said second user in response to said information of a favor of said second user.

5. A personal account collecting system as claimed in claim 3, wherein said communication service provider provides circumstances for establishing said service site for providing information managed by said information provider on the Internet, said communication service provider, in reward for the provision of said circumstances, obtaining advertisement charges from said advertising agent, responsive to an advertisement provided by said advertising agent.

6. A personal account collecting system as claimed in claim 5, wherein said communication service provider further provides said advertising agent with information of numbers of accesses to said mobile site by said first and second users responsive to an advertisement provided by said advertising agent.

7. A personal account collecting system as claimed in claim 5, wherein said communication service provider further provides said advertising agent with information of numbers of accounts collected by said collecting means of said information provider responsive to an advertisement provided by said advertising agent.

8. A personal account collecting system as claimed in claim 1, wherein said information of an account of said second user is an electronic mail address of said second user.

9. A personal account collecting system as claimed in claim 1, wherein said human networks are based on reliable human relations so that said second user is a family, a relative, a friend, or the like of said first user.

10. A method of collecting a personal account for use in collecting information of accounts of persons on Internet, said method comprising the steps of:
an information provider's managing a service site for providing information on the Internet;
a first user's getting access to said service site for providing information through a mobile site on the Internet in order to utilize said service site for providing information;
said first user's introducing a second user, as a target utilizing said service site for providing information, who is connected with said first user by human networks; and
said information provider's collecting information of an account of said second user in a database of said service site for providing information.

11. A method as claimed in claim 10, wherein said first user, by the use of a mobile personal telephone, gets access to said service site for providing information through a mobile site established on the Internet by a communication service provider.

12. A method as claimed in claim 10, wherein said information provider is an advertising agent.

13. A method as claimed in claim 12, wherein not only said information of an account of said second user but also information of a favor of said second user are registered in said data base of said service site for providing information, said advertising agent transferring an advertisement to said second user in response to said information of a favor of said second user.

14. A method as claimed in claim 12, wherein said communication service provider provides circumstances for establishing said service site for providing information managed by said information provider on the Internet, said communication service provider, in reward for the provision of said circumstances, obtaining advertisement charges from said advertising agent, responsive to an advertisement provided by said advertising agent.

15. A method as claimed in claim 14, wherein said communication service provider further provides said advertising agent with information of numbers of accesses to said mobile site by said first and second users responsive to an advertisement provided by said advertising agent.

16. A method as claimed in claim 14, wherein said communication service provider further provides said advertising agent with information of numbers of accounts collected by said collecting means of said information provider responsive to an advertisement provided by said advertising agent.

17. A method as claimed in claim 10, wherein said information of an account of said second user is an electronic mail address of said second user.

18. A method as claimed in claim 10, wherein said human networks are based on reliable human relations so that said second user is a family, a relative, a friend, or the like of said first user.
